(19) United States
(12) Patent Application Publication
(10) Pub. No.: US 2024/0332757 A1
(43) Pub. Date: Oct. 3, 2024

(54) BATTERY MODULE OF A BATTERY PACK FOR AN ELECTRIC VEHICLE

(71) Applicant: GM Global Technology Operations LLC, Detroit, MI (US)

(72) Inventors: Yi Liu, Troy, MI (US); Qigui Wang, Rochester Hills, MI (US); Huaxin Li, Rochester Hills, MI (US); Kestutis A. Sonta, Troy, MI (US); Daniel J. Wilson, Linden, MI (US)

(21) Appl. No.: 18/194,061

(22) Filed: Mar. 31, 2023

(51) Int. Cl. H01M 50/559; H01M 4/66; H01M 10/44; H01M 50/213; H01M 50/51; H01M 50/512

(52) U.S. Cl. CPC H01M 50/559; H01M 4/667; H01M 10/441; H01M 50/213; H01M 50/51; H01M 50/512; H01M 2220/20

(57) ABSTRACT

A vehicular battery module comprises a plurality of battery cells having a first end and a second end. Each battery cell comprises a first portion extending to a second portion. Each first portion has a conductive first terminal and each second portion has a conductive second terminal. The module further comprises at least one cell holder in which the plurality of battery cells is disposed. The module further comprises first and second current collectors. The first current collector comprises a first metal substrate and a first copper-graphene (Cu-Gr) multilayer composite disposed on the first metal substrate. The first current collector is disposed on the first end of the plurality of battery cells. The second current collector comprises a second metal substrate and a second Cu-Gr multilayer composite disposed on the second metal substrate. The second current collector is disposed on the second end of the plurality of battery cells.

### INTRODUCTION

The present disclosure relates to battery modules of battery packs for battery electric vehicles and, more particularly, systems for battery modules having current collectors with conductive composites.

With increasing demand of fuel efficiency and particularly reduction of greenhouse gas emissions, today's automotive industry has begun a new era of manufacturing environmentally friendly zero-emission vehicles such as battery electric vehicles. Current challenges are met to increase electric power density and lower energy consumption.

### SUMMARY

Thus, while current systems for battery modules having current collectors with conductive materials achieve their intended purpose, there is a need for a new and improved system for a battery module of a battery pack for a battery electric vehicle to increase electric power density and lower energy consumption.

In accordance with one aspect of the present disclosure, a battery module for a battery pack in a battery electric vehicle is provided. The battery module comprises a plurality of battery cells for electric energy. The plurality of battery cells has a first end and a second end. Each battery cell comprises a negative portion extending to a positive portion. Each negative portion has a conductive negative terminal and each positive portion has a conductive positive terminal opposite the negative terminal for electric current flow therethrough. The battery module further comprises at least one cell holder in which the plurality of battery cells are disposed.

The battery module further comprises a first current collector comprising a first metal substrate having first and second opposing surfaces. The first metal substrate comprises a first copper-graphene (Cu-Gr) multilayer composite disposed on the first surface and a second Cu-Gr multilayer composite disposed on the second surface of the first metal substrate. The first current collector is disposed on the first end of the plurality of battery cells for electric current to flow therethrough from the battery cells.

The battery module further comprises a second current collector comprising third and fourth opposing surfaces. The second metal substrate comprises a third Cu-Gr multilayer composite disposed on the third surface and a fourth Cu-Gr multilayer composite disposed on the fourth surface of the second metal substrate. The second current collector is disposed on the second end of the plurality of battery cells for electric current to flow therethrough from the battery cells.

In one embodiment, the first metal substrate has a thickness of between 5 microns and 25 microns. In another embodiment, the second metal substrate has a thickness of between 5 microns and 25 microns. In yet another embodiment, the first and second metal substrates comprise one of copper, aluminum, and steel (including carbon steel and stainless steel).

In one embodiment, each of the first and second Cu-Gr multilayer composite comprises at least two Cu-Gr layers. Moreover, each Cu-Gr layer of the first and second Cu-Gr multilayers comprises copper and graphene and has a thickness of 0.1 micron and 0.5 micron. In another embodiment, each of the third and fourth Cu-Gr multilayer composite comprises at least two Cu-Gr layers. Additionally, each Cu-Gr layer of the third and fourth Cu-Gr multilayer composites comprises copper and graphene and has a thickness of 0.1 and 0.5 micron.

In another embodiment, each of the first Cu-Gr multilayer composite, the second Cu-Gr multilayer composite, the third Cu-Gr multilayer composite, and the fourth Cu-Gr multilayer composite has a thickness of 0.2 micron to 200 micron. In yet another embodiment, each of the first Cu-Gr multilayer composite, the second Cu-Gr multilayer composite, the third Cu-Gr multilayer composite, and the fourth Cu-Gr multilayer composite has a graphene volume fraction of 0.002% to 0.2%. In still another embodiment, the plurality of battery cells is arranged in one of a series connection and a parallel connection.

In accordance with another aspect of the present disclosure, a system for electrically connecting battery modules of a battery pack in a battery electric vehicle is provided. The system comprises a battery pack comprising a plurality of battery modules. The battery pack is arranged to discharge direct current having a first voltage for electric power.

In this aspect, each battery module comprises a plurality of battery cells for electric energy. The plurality of battery cells has a first end and a second end. Each battery cell comprises a negative portion extending to a positive portion. Each negative portion has a conductive negative terminal and each positive portion has a conductive positive terminal opposite the negative terminal for electric current flow therethrough. Each battery module further comprises at least one cell holder in which the plurality of battery cells is disposed.

Each battery module of the battery pack further comprises a first current collector comprising a first metal substrate having first and second opposing surfaces. The first metal substrate comprises a first copper-graphene (Cu-Gr) multilayer composite disposed on the first surface and a second Cu-Gr multilayer composite disposed on the second surface of the first metal substrate. The first current collector is disposed on the first end of the plurality of battery cells for electric current to flow therethrough from the battery cells.

Each battery module of the battery pack further comprises a second current collector comprising third and fourth opposing surfaces. The second metal substrate comprises a third Cu-Gr multilayer composite disposed on the third surface and a fourth Cu-Gr multilayer composite disposed on the fourth surface of the second metal substrate. The second current collector is disposed on the second end of the plurality of battery cells for electric current to flow therethrough from the battery cells.

In this aspect, the system further comprises an AC/DC converter in communication with the battery pack. The AC/DC converter is arranged to convert direct current from the battery pack to alternating current for electric power to an electric motor of the vehicle. The system further comprises a DC/DC converter in communication with the battery pack. The DC/DC converter is arranged to convert direct current from the first voltage to a second voltage for electric power to electric components of the vehicle.

The system further comprises a battery charger in communication with the battery pack. The battery charger is arranged to charge the battery pack with a remote electrical energy source. The system further comprises a controller in communication with the battery charger and the battery pack. The controller is arranged to control the battery charger and the battery pack.

In one embodiment, the first metal substrate has a thickness of between 5 microns and 25 microns. In another embodiment, the second metal substrate has a thickness of between 5 microns and 25 microns. In yet another embodiment, the first and second metal substrates comprise one of copper, aluminum, and steel including carbon steel and stainless steel.

In one embodiment, each of the first and second Cu-Gr multilayer composite comprises at least two Cu-Gr layers. Moreover, each Cu-Gr layer of the first and second Cu-Gr multilayers comprises copper and graphene and has a thickness of 0.1 micron and 0.5 micron. In another embodiment, each of the third and fourth Cu-Gr multilayer composite comprises at least two Cu-Gr layers. Additionally, each Cu-Gr layer of the third and fourth Cu-Gr multilayer composites comprises copper and graphene and has a thickness of 0.1 and 0.5 micron.

In another embodiment, each of the first Cu-Gr multilayer composite, the second Cu-Gr multilayer composite, the third Cu-Gr multilayer composite, and the fourth Cu-Gr multilayer composite has a thickness of 0.2 micron to 200 micron. In yet another embodiment, each of the first Cu-Gr multilayer composite, the second Cu-Gr multilayer composite, the third Cu-Gr multilayer composite, and the fourth Cu-Gr multilayer composite has a graphene volume fraction of 0.002% to 0.2%. In still another embodiment, the plurality of battery cells is arranged in one of a series connection and a parallel connection.

In accordance with yet another aspect of the present disclosure, a battery module for a battery pack in a battery electric vehicle is provided. The battery module comprises a plurality of battery cells for electric energy. The plurality of battery cells has a first end and a second end. Each battery cell comprises a negative portion extending to a positive portion. Each negative portion has a conductive negative terminal and each positive portion has a conductive positive terminal opposite the negative terminal for electric current flow therethrough. The battery module further comprises at least one cell holder in which the plurality of battery cells is disposed.

The battery module further comprises a first current collector comprising a first copper-graphene (Cu-Gr) multilayer composite. The first current collector is disposed on the first end of the plurality of battery cells for electric current to flow therethrough from the battery cells. The first Cu-Gr multilayer composite comprises at least two Cu-Gr layers. Each Cu-Gr layer of the first Cu-Gr multilayer comprises copper and graphene and has a thickness of 0.1 micron and 0.5 micron.

The battery module further comprises a second current collector comprising a second Cu-Gr multilayer composite. The second current collector is disposed on the second end of the plurality of battery cells for electric current to flow therethrough from the battery cells. The second Cu-Gr multilayer composite comprises at least two Cu-Gr layers. Each Cu-Gr layer of the second Cu-Gr layer comprises copper and graphene and has a thickness of 0.1 and 0.5 micron.

In one embodiment, each of the first and second Cu-Gr multilayer composites has a thickness of 0.2 micron to 200 micron.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic view of a system for electrically connecting battery modules of a battery pack in a battery electric vehicle in accordance with one embodiment of the present disclosure.

FIG. 2A is a perspective view of a battery module in FIG. 1 in accordance with one embodiment of the present disclosure.

FIG. 2B is an exploded view of the batter module in FIG. 2A.

FIG. 3A is a conceptual cross-sectional side view of a first current collector of the battery module in FIG. 2B taken along lines 3A-3A in accordance with one embodiment.

FIG. 3B is a conceptual cross-sectional side view of a second current collector of the battery module in FIG. 2B taken along lines 3B-3B in accordance with one embodiment.

FIG. 4 is a conceptual cross-sectional side view of a current collector of the battery module in FIG. 2B taken along lines 4-4 in accordance with yet another embodiment.

FIG. 5 is a conceptual cross-sectional side view of a current collector of the battery module in FIG. 2B taken along lines 5-5 in accordance with still another embodiment.

FIG. 6A is a partial plan view of a current collector of the battery module in FIG. 2B in accordance with one embodiment.

FIG. 6B is a partial plan view of a current collector of the battery module in FIG. 2B in accordance with another embodiment.

### DETAILED DESCRIPTION

The following description is merely exemplary in nature and is not intended to limit the present disclosure, application, or uses.

Embodiments and examples of the present disclosure provide systems for electrically connecting battery modules of a battery pack in a battery electric vehicle. Each battery module comprises a current collector having metal substrate to which a copper-graphene multilayer composite is disposed. The copper-graphene multilayer composite provides increased conductivity resulting in increased efficiency and energy savings.

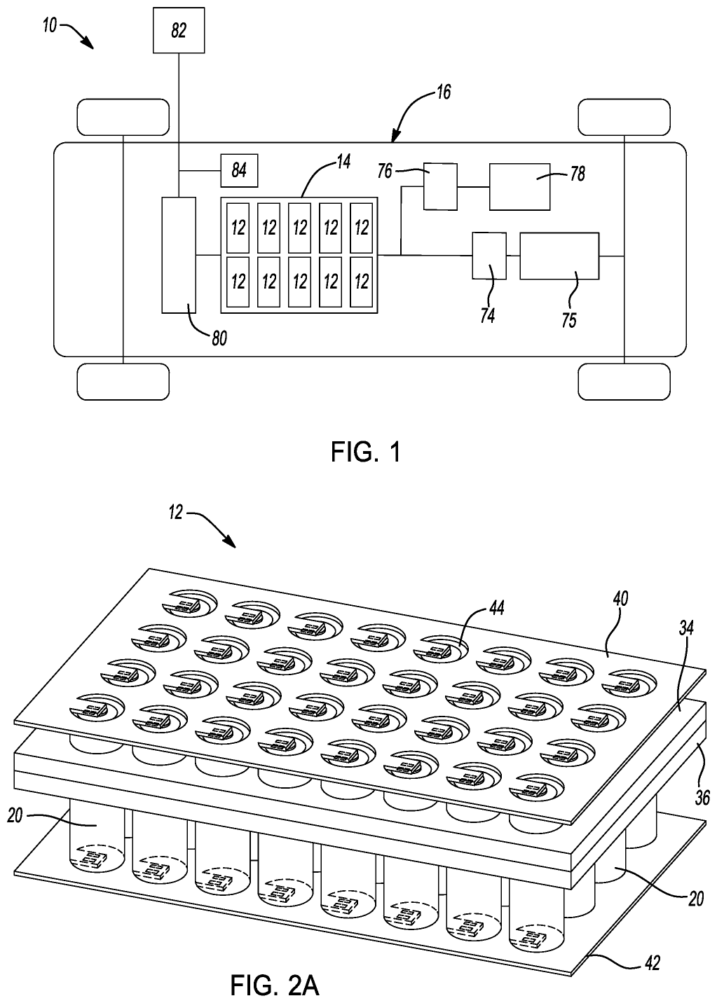

FIG. 1 illustrates a system 10 for electrically connecting one or a plurality of battery modules 12 of a battery pack 14 in a battery electric vehicle 16. As shown, the system 10 comprises a battery pack 14 comprising one battery module or a plurality of battery modules 12. In this embodiment, the battery pack 14 comprises a plurality of battery modules 12 such as ten. However, it is to be understood that more battery modules or less battery modules may be used without departing from the spirit or scope of the present disclosure. The battery pack 14 is arranged to collect current from each of the plurality of battery modules 12 and aggregately discharge direct current having a first voltage for electric power to the vehicle 16.

The system 10 further comprises an AC/DC converter 74, a DC/DC converter 76, a battery charger 80, and a controller 84 each of which is discussed in greater detail below.

The first voltage may be at least 200 volts. Preferably, the first voltage may be 300 volts, 400 volts, 500 volts, 600 volts, 700 volts, and 800 volts. Each battery module 12 may discharge at least 50 volts of direct current. Preferably, each battery module 12 may discharge 60 volts, 70 volts, 80 volts, 90 volts, 100 volts, 110 volts, 120 volts, 130 volts, 140 volts, and 150 volts.

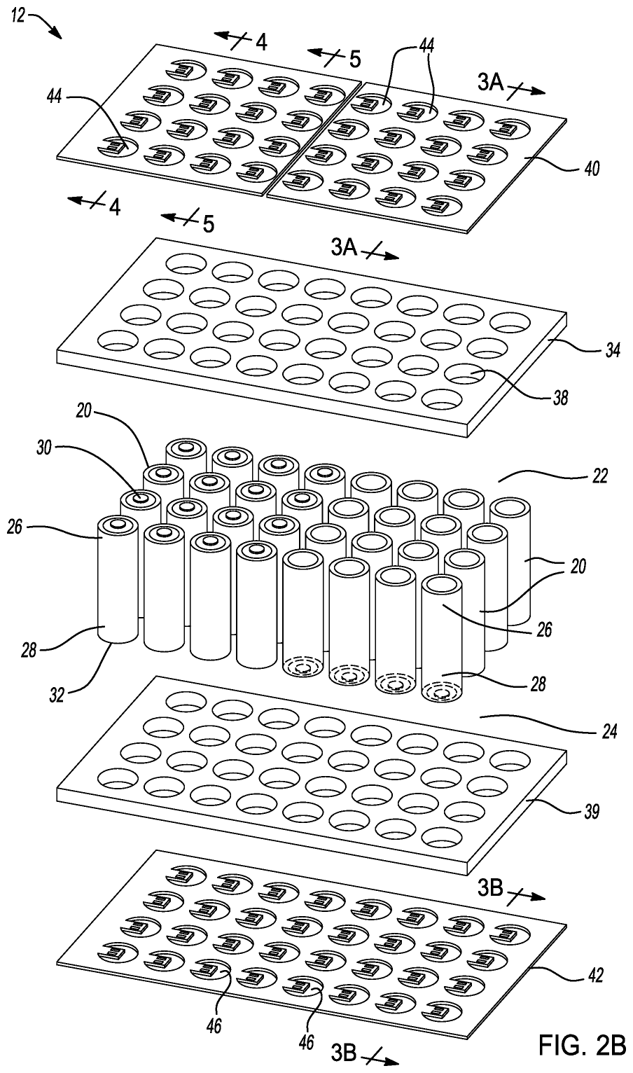

Referring to FIGS. 1-2B, each battery module 12 comprises a plurality of battery cells 20 for conversion of chemical energy to electric energy to the vehicle 16. As shown, the plurality of battery cells 20 has a first end 22 and a second end 24. Each battery cell 20 comprises a first portion 26 extending to a second portion 28. Moreover, each first portion 26 has a conductive first terminal 30 and each second portion 28 has a conductive second terminal 32 opposite the first terminal 30 for electric current flow therethrough.

In one embodiment, the plurality of battery cells 20 may be at least 2000 battery cells. Preferably, the plurality of battery cells 20 may be 3000, 4000 battery cells, 5000 battery cells, 7500 battery cells, 10,000 battery cells, 15,000 battery cells, 20,000 battery cells, 25,000 battery cells, 30,000 battery cells, 35,000 battery cells, and 40,000 battery cells. In this embodiment, each battery cell 20 may discharge at least 2 volts of direct current. Preferably, each battery cell 20 may discharge 3.0 volts, 3.6 volts, 4 volts, 5 volts, 6 volts, 7 volts, 8 volts, 9 volts, 10 volts, 12 volts, 14 volts, 16 volts, 18 volts and 20 volts. Furthermore, the plurality of battery cells 20 may be arranged in a series connection, a parallel connection or any other suitable manner without departing from the spirit or scope of the present disclosure.

Referring to FIGS. 2A-2B, each battery module 12 further comprises at least one cell holder in which the plurality of battery cells 20 is disposed. In this embodiment, the at least one cell holder comprises a first cell holder 34 and a second cell holder 36. The first cell holder 34 comprises first apertures 38 through which the battery cells 20 are disposed such that the first cell holder 34 is arranged proximal to the first end 22. Moreover, the second cell holder 36 comprises second apertures 39 through which the battery cells 20 are disposed such that the second cell holder 36 is arranged proximal to the second end 24.

FIGS. 2A and 2B illustrate that each battery module 12 of the battery pack 14 further comprises a first current collector 40 and a second current collector 42. As shown, the first current collector 40 is disposed on the first end 22 of the plurality of battery cells 20 for electric current to flow therethrough from the battery cells 20. As discussed in greater detail below, the first current collector 40 has first contact portion 44 formed thereon. Each of the first contact portion 44 is arranged to contact one of the conductive terminals of each battery.

Moreover, the second current collector 42 is disposed on the second end 24 of the plurality of battery cells 20 for electric current to flow therethrough from the battery cells 20. As discussed in greater detail below, the second current collector 42 has second contact portion 46 formed thereon. Each of the second contact portion 46 is arranged to contact one of the conductive terminals of each battery.

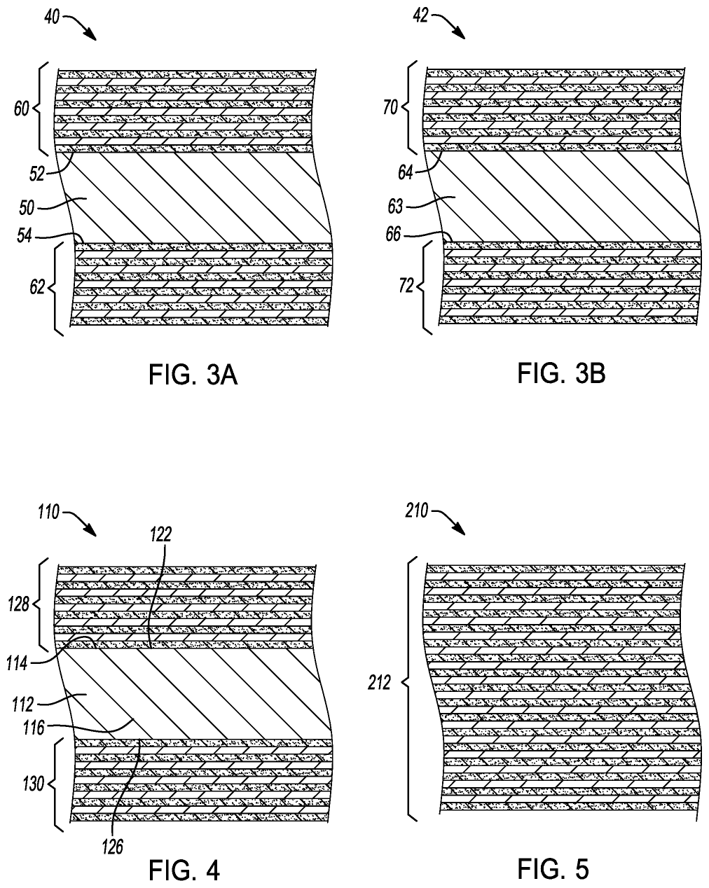

Referring to FIG. 3A, the first current collector 40 comprises a first metal substrate 50 having first and second opposite surfaces 52, 54. The first metal substrate 50 comprises a first copper-graphene (Cu-Gr) multilayer composite 60 disposed on the first surface 52 and a second Cu-Gr multilayer composite 62 disposed on the second surface 54 of the first metal substrate 50. The first current collector 40 is disposed on the first end 22 of the plurality of battery cells 20 for electric current to flow therethrough from the battery cells 20. Preferably, the first metal substrate 50 has a thickness of between 5 microns and 25 microns. Preferably, the first metal substrate 50 may have a thickness of 6 microns, 7 microns, 8 microns, 9 microns, 10 microns, 11 microns, 12 microns, 13 microns, 14 microns, 15 microns, 16 microns, 17 microns, 18 microns, 19 microns, 20 microns, 21 microns, 22 microns, 23 microns, and 24 microns. Furthermore the first metal substrate 50 may comprise one of copper, aluminum, and carbon steel.

In one embodiment, each of the first and second Cu-Gr multilayer composites 60, 62 comprises at least two Cu-Gr layers, preferably six or more Cu-Gr layers. It is to be understood that the first and second Cu-Gr multilayers may comprise a number of Cu-Gr layers including 7, 8, 9, 10, 15, 20, 25, 30, 35, 40, 45, 50, 55, 60, 65, 70, 75, 80, 85, 90, 95, and 100 Cu-Gr layers. Moreover, each Cu-Gr layer of the first and second Cu-Gr multilayers comprises copper and graphene and has a thickness of 0.1 micron and 0.5 micron. Preferably, each Cu-Gr layer may have a thickness of 0.2 micron, 0.3 micron, and 0.4 micron. Additionally, each of the first and second Cu-Gr multilayer composites 60, 62 has a thickness of 0.2 micron to 200 micron, preferably 1.3 micron. Preferably, each of the first and second multilayer composites 60, 62 may have a thickness of 0.3 micron, 0.4 micron, 0.5 micron, 1.0 micron, 1.5 micron, 2.0 microns, 2.5 microns, 3.0 microns, 3.5 microns, 4.0 microns, 4.5 microns, 5.0 microns, 5.5 microns, 6.0 microns, 6.5 microns, 7.0 microns, 7.5 microns, 8.0 microns, 8.5 microns, 9.0 microns, 9.5 microns, 10 microns, 25 microns, 50 microns, 75 microns, 100 microns, 125 microns, 150 microns, and 175 microns. Furthermore, each of the first and second Cu-Gr multilayer composites 60, 62 has a graphene volume fraction of 0.002% to 0.2%. Preferably, each of the first and second Cu-Gr multilayer composites 60, 62 may have a graphene volume fraction of 0.003%, 0.004%, 0.005%, 0.006%, 0.007%, 0.008%, 0.009%, 0.010%, 0.011%, 0.012%, 0.014%, 0.016%, 0.018%, 0.02%, 0.05%, 0.075%, 0.1%, 0.125%, 0.15%, and 0.175%.

As depicted in FIG. 3B and similar to the first current collector 40, the second current collector 42 comprises a second metal substrate 63 having third and fourth opposite surfaces 64, 66. The second metal substrate 63 comprises a third Cu-Gr multilayer composite 70 disposed on the third surface 64 and a fourth Cu-Gr multilayer composite 72 disposed on the fourth surface 66 of the second metal substrate 63. The second current collector 42 is disposed on the second end 24 of the plurality of battery cells 20 for electric current to flow therethrough from the battery cells 20. Preferably, the second metal substrate 63 has a thickness of between 5 microns and 25 microns. Preferably, the second metal substrate 63 may have a thickness of 6 microns, 7 microns, 8 microns, 9 microns, 10 microns, 11 microns, 12 microns, 13 microns, 14 microns, 15 microns, 16 microns, 17 microns, 18 microns, 19 microns, 20 microns, 21 microns, 22 microns, 23 microns, and 24 microns. Furthermore the second metal substrate 63 may comprise one of copper, aluminum, and carbon steel.

In another embodiment, each of the third and fourth Cu-Gr multilayer composite 70, 72 comprises at least two Cu-Gr layers, preferably 10 to 100 Cu-Gr layers. It is to be understood that the third and fourth Cu-Gr multilayers may comprise a number of Cu-Gr layers including 7, 8, 9, 10, 15, 20, 25, 30, 35, 40, 45, 50, 55, 60, 65, 70, 75, 80, 85, 90, 95, and 100 Cu-Gr layers. Additionally, each Cu-Gr layer of the third and fourth Cu-Gr multilayer composites 70, 72 comprises copper and graphene and has a thickness of 0.1 and 0.5 micron. Preferably, each Cu-Gr layer may have a thickness of 0.2 micron, 0.3 micron, and 0.4 micron. In addition, each of the third and fourth Cu-Gr multilayer composites 70, 72 has a thickness of 0.2 micron to 200 microns. Preferably, each of the third and fourth multilayer composites 70, 72 may have a thickness of 0.3 micron, 0.4 micron, 0.5 micron, 1.0 micron, 1.5 micron, 2.0 microns, 2.5 microns, 3.0 microns, 3.5 microns, 4.0 microns, 4.5 microns, 5.0 microns, 5.5 microns, 6.0 microns, 6.5 microns, 7.0 microns, 7.5 microns, 8.0 microns, 8.5 microns, 9.0 microns, 9.5 microns, 10 microns, 25 microns, 50 microns, 75 microns, 100 microns, 125 microns, 150 microns, and 175 microns. Furthermore, each of the third and fourth Cu-Gr multilayer composites 70, 72 has a graphene volume fraction of 0.002% to 0.2%. Preferably, each of the third and fourth Cu-Gr multilayer composites 70, 72 may have a graphene volume fraction of 0.003%, 0.004%, 0.005%, 0.006%, 0.007%, 0.008%, 0.009%, 0.010%, 0.011%, 0.012%, 0.014%, 0.016%, 0.018%, 0.02%, 0.05%, 0.075%, 0.1%, 0.125%, 0.15%, and 0.175%.

In accordance with another embodiment, FIG. 4 illustrates an aluminum current collector 110 having an aluminum substrate 112 comprising aluminum. As shown, the aluminum substrate 112 comprises a first surface 114 and a second surface 116 opposite the first surface 114. As depicted, a first aluminum oxide (Al₂O₃) or alumina layer 120 is formed on the first surface 114 defining a first contact surface 122 of the first aluminum oxide layer 120. Moreover, a second aluminum oxide layer 124 is formed on the second surface 116 defining a second contact surface 126 of the second aluminum oxide layer 124. Referring to FIG. 4, a first plurality of Cu-Gr layers 128 is disposed on the first contact surface 122 of the first aluminum oxide layer 120. Further, a second plurality of Cu-Gr layers 130 is disposed on the second contact surface 126 of the second aluminum oxide layer 124. Having no or low conductivity, the aluminum oxide layers 120, 124 are used as a conductive barrier thereby allowing electrical current to flow through the Cu-Gr layers 128, 130 of the aluminum current collector 110.

FIG. 5 illustrates a Cu-Gr multilayer current collector 210 in accordance with another embodiment. In this embodiment, the current collector 210 comprises a plurality of Cu-Gr layers 212 only and may be implemented similarly to the first and second current collectors 40, 42 in the previous embodiment. That is, a first Cu-Gr multilayer current collector may be disposed on the first end of the plurality of battery cells for electric current to flow therethrough from the battery cells. Moreover, the first Cu-Gr multilayer current collector may comprise at least two Cu-Gr layers wherein each Cu-Gr layer comprises copper and graphene and has a thickness of 0.1 micron and 0.5 micron. Moreover, a second Cu-Gr multilayer current collector may be disposed on the second end of the plurality of battery cells for electric current to flow therethrough from the battery cells. Moreover, the second Cu-Gr multilayer current collector may comprise at least two Cu-Gr layers wherein each Cu-Gr layer comprises copper and graphene and has a thickness of 0.1 micron and 0.5 micron. It is to be understood that each of the first and second multilayer current collectors may comprise a number of Cu-Gr layers including 7, 8, 9, 10, 15, 20, 25, 30, 35, 40, 45, 50, 55, 60, 65, 70, 75, 80, 85, 90, 95, and 100 Cu-Gr layers. Moreover, each Cu-Gr layer may comprise copper and graphene and have a thickness of 0.1 micron and 0.5 micron. Preferably, each Cu-Gr layer may have a thickness of 0.2 micron, 0.3 micron, and 0.4 micron.

In this embodiment, each Cu-Gr layer has a thickness of 0.2 micron to 200 microns. Preferably, each Cu-Gr layer may have a thickness of 0.3 micron, 0.4 micron, 0.5 micron, 1.0 micron, 1.5 micron, 2.0 microns, 2.5 microns, 3.0 microns, 3.5 microns, 4.0 microns, 4.5 microns, 5.0 microns, 5.5 microns, 6.0 microns, 6.5 microns, 7.0 microns, 7.5 microns, 8.0 microns, 8.5 microns, 9.0 microns, 9.5 microns, 10 microns, 25 microns, 50 microns, 75 microns, 100 microns, 125 microns, 150 microns, and 175 microns. Furthermore, each Cu-Gr layer may have a graphene volume fraction of at least 0.002%. Preferably, each of the third and fourth Cu-Gr multilayer composites 70, 72 may have a graphene volume fraction of 0.003%, 0.004%, 0.005%, 0.006%, 0.007%, 0.008%, 0.009%, 0.010%, 0.011%, 0.012%, 0.014%, 0.016%, 0.018%, 0.02%, 0.05%, 0.075%, 0.1%, 0.125%, 0.15%, and 0.175% or higher.

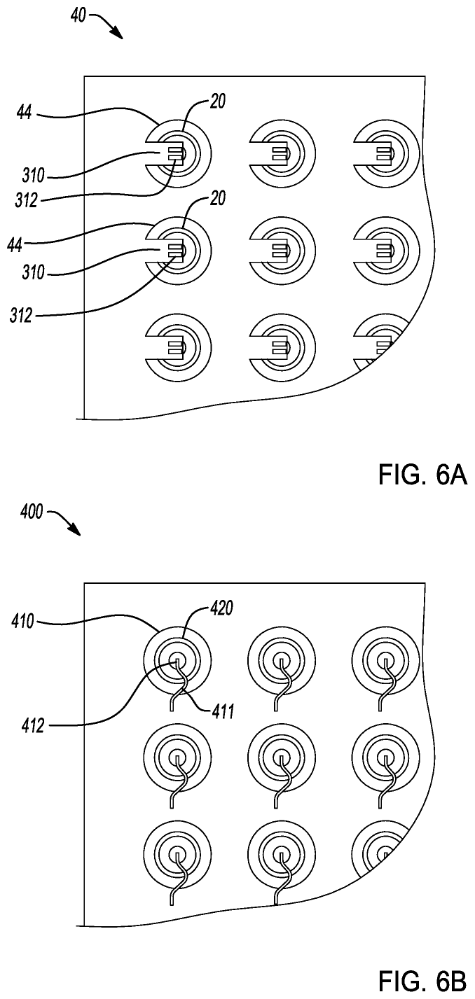

Referring back to FIGS. 1-2B, and 6A, each of the contact portions 44, 46 of the first current collector 40 (FIG. 6A) and the second current collector 42 may have a contact tab 310 that may be attached by any suitable manner to one of the terminals of each battery cell 20. For example, the contact tabs 310 of the first current collector 40 (depicted in FIG. 6A) may be laser welded resulting in a weld 312 to the battery terminals that are proximal the first end 22 (see FIG. 2B). Along these lines, contact tabs of the second current collector may be laser welded at the contact portions to the battery terminals that are proximal the second end.

Referring to FIG. 6B, each of the contact portions 410 of a first current collector 400 (FIG. 6B) and each of the contact portions of a second current collector may have a contact wire 411 that may be bonded or attached by any suitable manner to one of the terminals of each battery cell 420. For example, the contact wire of the first current collector may be ultrasonically welded resulting in a weld 412 to the battery terminals that are proximal the second end. Along these lines, the contact wire of the second current collector may be ultrasonically welded to the battery terminals that are proximal the second end.

Referring back to FIG. 1, the system 10 further comprises an AC/DC converter 74 in electrical communication with the battery pack 14. The AC/DC converter 74 is arranged to convert direct current (DC) from the battery pack 14 to alternating current (AC) for electric power to an electric motor 75 of the vehicle 16. As depicted in FIG. 1, the system 10 further comprises a DC/DC converter 76 in electrical communication with the battery pack 14. The DC/DC converter 76 is arranged to convert direct current from the first voltage to a second voltage for electric power to electric components 78 of the vehicle 16. Such components 78 may include vehicle motor units, sensors, electronic control modules, controllers, engine gauges, automatic wipers, power windows, power mirrors, an HVAC system, dashboard electronics and controls, interior and exterior lights, and radio/audio systems. Other electric components may be powered by the system without departing from the spirit or scope of the present disclosure.

The system 10 further comprises a battery charger 80 in electrical communication with the battery pack 14. The battery charger 80 is arranged to charge the battery pack 14 by way of a remote electrical energy source 82, e.g., a BEV charging station. The system 10 further comprises a controller 84 in electrical communication with the battery charger 80 and the battery pack 14. The controller 84 is arranged to control the battery charger 80 and the battery pack 14.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A battery module for a battery pack in a battery electric vehicle, the battery module comprising:
a plurality of battery cells for electric energy, the plurality of battery cells having a first end and a second end, each battery cell comprising a negative portion extending to a positive portion, each negative portion having a conductive negative terminal and each positive portion having a conductive positive terminal opposite the negative terminal for electric current flow therethrough;
at least one cell holder in which the plurality of battery cells is disposed;
a first current collector comprising a first metal substrate having first and second opposing surfaces, the first metal substrate comprising a first copper-graphene (Cu-Gr) multilayer composite disposed on the first surface and a second Cu-Gr multilayer composite disposed on the second surface of the first metal substrate, the first current collector disposed on the first end of the plurality of battery cells for electric current to flow therethrough from the battery cells; and
a second current collector comprising a second metal substrate having third and fourth opposing surfaces, the second metal substrate comprising a third Cu-Gr multilayer composite disposed on the third surface and a fourth Cu-Gr multilayer composite disposed on the fourth surface of the second metal substrate, the second current collector disposed on the second end of the plurality of battery cells for electric current to flow therethrough from the battery cells.

2. The battery module of claim 1 wherein the first metal substrate has a thickness of between 5 microns and 25 microns.

3. The battery module of claim 1 wherein the second metal substrate has a thickness of between 5 microns and 25 microns.

4. The battery module of claim 1 wherein each of the first and second metal substrates comprises one of copper, aluminum, carbon steel and stainless steel.

5. The battery module of claim 1 wherein each of the first and second Cu-Gr multilayer composites comprises at least two Cu-Gr layers, and
wherein each Cu-Gr layer of the first and second Cu-Gr multilayer comprises copper and graphene and has a thickness of 0.1 micron and 0.5 micron.

6. The battery module of claim 1 wherein each of the third and fourth Cu-Gr multilayer composites comprises at least two Cu-Gr layers, and
wherein each Cu-Gr layer of the third and fourth Cu-Gr multilayer composites comprises copper and graphene and has a thickness of 0.1 and 0.5 micron.

7. The battery module of claim 1 wherein each of the first Cu-Gr multilayer composite, the second Cu-Gr multilayer composite, the third Cu-Gr multilayer composite, and the fourth Cu-Gr multilayer composite has a thickness of 0.2 micron to 200 micron.

8. The battery module of claim 1 wherein each of the first Cu-Gr multilayer composite, the second Cu-Gr multilayer composite, the third Cu-Gr multilayer composite, and the fourth Cu-Gr multilayer composite has a graphene volume fraction of 0.002% to 0.2%.

9. The battery module of claim 1 wherein the plurality of battery cells is arranged in one of a series connection and a parallel connection.

10. A system for electrically connecting battery modules of a battery pack in a battery electric vehicle, the system comprising:
a battery pack comprising a plurality of battery modules, the battery pack arranged to discharge direct current having a first voltage for electric power, each battery module comprising:
a plurality of battery cells for electric energy, the plurality of battery cells having a first end and a second end, each battery cell comprising a negative portion extending to a positive portion, each negative portion having a conductive negative terminal and each positive portion having a conductive positive terminal opposite the negative terminal for electric current flow therethrough;
at least one cell holder in which the plurality of battery cells is disposed;
a first current collector comprising a first metal substrate having first and second opposing surfaces, the first metal substrate comprising a first copper-graphene (Cu-Gr) multilayer composite disposed on the first surface and a second Cu-Gr multilayer composite disposed on the second surface of the first metal substrate, the first current collector disposed on the first end of the plurality of battery cells for electric current to flow therethrough from the battery cells; and
a second current collector comprising a second metal substrate having third and fourth opposing surfaces, the second metal substrate comprising a third Cu-Gr multilayer composite disposed on the third surface and a fourth Cu-Gr multilayer composite disposed on the fourth surface of the second metal substrate, the second current collector disposed on the second end of the plurality of battery cells for electric current to flow therethrough from the battery cells;
an AC/DC converter in communication with the battery pack, the AC/DC converter arranged to convert direct current from the battery pack to alternating current for electric power to an electric motor of the vehicle;
a DC/DC converter in communication with the battery pack, the DC/DC converter arranged to convert direct current from the first voltage to a second voltage for electric power to electric components of the vehicle;
a battery charger in communication with the battery pack, the battery charger arranged to charge the battery pack with a remote electrical energy source; and
a controller in communication with the battery charger and the battery pack, the controller arranged to control the battery charger and the battery pack.

11. The system of claim 10 wherein the first metal substrate has a thickness of between 5 microns and 25 microns.

12. The system of claim 10 wherein the second metal substrate has a thickness of between 5 microns and 25 microns.

13. The system of claim 10 wherein the first and second metal substrates comprise one of copper, aluminum, and carbon steel.

14. The system of claim 10 wherein each of the first and second Cu-Gr multilayer composites comprises at least two Cu-Gr layers, and wherein each Cu-Gr layer of the first and second Cu-Gr multilayer comprises copper and graphene and has a thickness of 0.1 micron and 0.5 micron.

15. The system of claim 10 wherein each of the third and fourth Cu-Gr multilayer composites comprises at least two Cu-Gr layers, and wherein each Cu-Gr layer of the third and fourth Cu-Gr multilayer composites comprises copper and graphene and has a thickness of 0.1 and 0.5 micron.

16. The system of claim 10 wherein each of the first Cu-Gr multilayer composite, the second Cu-Gr multilayer composite, the third Cu-Gr multilayer composite, and the fourth Cu-Gr multilayer composite has a thickness of 0.2 micron to 200 micron.

17. The system of claim 10 wherein each of the first Cu-Gr multilayer composite, the second Cu-Gr multilayer composite, the third Cu-Gr multilayer composite, and the fourth Cu-Gr multilayer composite has a graphene volume fraction of 0.002% to 0.2%.

18. The system of claim 10 wherein the plurality of battery cells is arranged in one of a series connection and a parallel connection.

19. A battery module for a battery pack in a battery electric vehicle, the battery module comprising:
a plurality of battery cells for electric energy, the plurality of battery cells having a first end and a second end, each battery cell comprising a negative portion extending to a positive portion, each negative portion having a conductive negative terminal and each positive portion having a conductive positive terminal opposite the negative terminal for electric current flow therethrough;
at least one cell holder in which the plurality of battery cells is disposed;
a first current collector comprising a first copper-graphene (Cu-Gr) multilayer composite, the first current collector disposed on the first end of the plurality of battery cells for electric current to flow therethrough from the battery cells, the first Cu-Gr multilayer composite comprising at least two Cu-Gr layers, each Cu-Gr layer of the first Cu-Gr multilayer comprising copper and graphene and having a thickness of 0.1 micron and 0.5 micron, and
a second current collector comprising a second Cu-Gr multilayer composite, the second current collector disposed on the second end of the plurality of battery cells for electric current to flow therethrough from the battery cells, the second Cu-Gr multilayer composite comprising at least two Cu-Gr layers, each Cu-Gr layer of the second Cu-Gr layer comprising copper and graphene and having a thickness of 0.1 and 0.5 micron.

20. The battery module of claim 19 wherein each of the first and second Cu-Gr multilayer composites has a thickness of 0.2 micron to 200 micron.
